(19) United States
(12) Patent Application Publication
(10) Pub. No.: US 2016/0313976 A1
(43) Pub. Date: Oct. 27, 2016

(54) HIGH PERFORMANCE DIVISION AND ROOT COMPUTATION UNIT

(71) Applicant: QUALCOMM Incorporated, San Diego, CA (US)

(72) Inventors: Michael Thomas DIBRINO, Austin, TX (US); Kenneth Alan DOCKSER, Cary, NC (US); Pathik Sunil LALL, Raleigh, NC (US)

(21) Appl. No.: 14/691,576

(22) Filed: Apr. 21, 2015

(51) Int. Cl. G06F 7/52; G06F 7/537

(52) U.S. Cl. CPC G06F 7/52; G06F 7/537

(57) ABSTRACT

Systems and methods relate to a division/root computation unit. A lookup table according to a Sweeney, Robertson, and Tocher (SRT) algorithm for a division/root computation is stored in a memory. Information related to a selected column corresponding to a divisor/root estimate is stored in a high-speed memory. Division/root computation is performed iteratively using the cached information to improve access times and reduce latency of accessing the entire lookup table on each iteration. In each iteration, a quotient/root is determined from the cached information based on a current partial remainder, and a next partial remainder is generated based on the quotient/root, the divisor/root estimate, and the current partial remainder.

### FIELD OF DISCLOSURE

Disclosed aspects relate to high performance division and root computation units. More specifically, exemplary aspects relate to improvements in the speed and power consumption in the access of lookup tables used in division and/or root computation in processors.

### BACKGROUND

Computer systems or processors may include an arithmetic and logic unit (ALU) which performs arithmetic and logical operations on data. Some ALUs may include a floating-point unit that may be configured to perform division and/or root calculations (e.g., square root). Division and square root operations may be implemented in processors using similar algorithms which may operate in an iterative manner.

For example, a conventional algorithm used for performing division and/or square root calculations is known as a Sweeney, Robertson, and Tocher (SRT) algorithm. The SRT algorithm is iterative in nature. The iterations of the SRT algorithm may be implemented in a pipelined processor by performing one iteration per cycle, although it may also be possible to spread out each iteration over multiple clock cycles or pipeline stages. It is also possible to implement the SRT algorithm in a non-pipelined fashion, such as in an array divider. The SRT algorithm can produce one or more bits of the desired result (e.g., the quotient of a multiplication of the result of a square root operation) per iteration. The “radix” of a particular division or square root algorithm is an indication of the number of bits produced or computed in each iteration. For example, a radix-4 algorithm computes 2 bits of quotient in every iteration, whereas, increasing the radix to a radix-16 algorithm computes 4 bits in every iteration, which doubles the speed or reduces latency by half in comparison to the radix-4 algorithm. However, increasing the radix of the algorithm leads to increased complexity and associated hardware and/or software costs of the implementation of the algorithm.

Conventional implementations of the SRT algorithm involve a table lookup in each iteration. The table lookup is explained using a description of a conventional division process of dividing a dividend (or numerator) with a divisor (or denominator) to produce a result or quotient in one or more iterations. In the first iteration, the number of times the divisor goes into the dividend is determined. This number, also known as a multiple, forms one or more bits of the quotient (based on the radix). That multiple times the divisor is subtracted from the dividend to form a partial remainder. The operation then moves on to the next iteration where the dividend is replaced by the partial remainder. The steps related to determining the number of times the divisor goes into the partial remainder are repeated in order to obtain further bits of the quotient and the next partial remainder. This process is repeated until the partial remainder is zero, if the quotient is a rational number, or continues indefinitely if the quotient is irrational. In practice, the division process terminates when a predetermined precision of the quotient is reached.

The SRT algorithm simplifies the above process by providing a mapping of the values of partial remainders to quotient values for various possible values of divisors. A lookup table or two dimensional array is provided for this mapping, where, for example, divisors are disposed on an x-axis (or row direction) and partial remainders are disposed on a y-axis (or column direction). Quotient values are provided for each intersection on the x-y plane or for each combination of divisor values and partial remainder values. In some implementations, fewer than all bits of the divisor and/or partial remainder values (e.g., a predetermined number of most significant bits (MSBs) may be utilized in the mapping. It will be recognized that truncating the precision of the divisor and/or partial remainder values by using fewer bits may affect accuracy of the corresponding quotient values provided in the table. However, the size of the table, and correspondingly lookup time increases if higher precision/number of bits of divisor and/or partial remainder values are used.

Using the lookup table, in each iteration, the partial remainder (or a truncated version of the partial remainder) for that iteration is used to lookup the quotient bits for the particular divisor (or a truncated version) of the division. Depending on various parameters such as the radix of the SRT algorithm, number of bits of precision of the divisor and/or partial remainder values in the lookup table, etc., the speed of accessing the lookup table, as well as expenses in terms of area/cost of implementing the lookup tables can be very high. Accessing the lookup table is in the critical path of processing each iteration.

The case of determining the root (e.g., square root) of a number (or radicand) using a corresponding SRT algorithm is similar, where an initial estimate of the root is used in the table lookup instead of the divisor. While the root operation is not described in greater detail here, it will be recognized that the corresponding SRT algorithm also involves a table lookup in each iteration, which affects the speed and power consumption of implementing the SRT algorithm for root computation in processors.

Accordingly, there is a need in the art for overcoming the aforementioned limitations in conventional implementations of the SRT algorithm for division and/or root computations.

### SUMMARY

Exemplary aspects of this disclosure pertain to systems and methods for division/root computation. A lookup table according to a Sweeney, Robertson, and Tocher (SRT) algorithm for a division/root computation is stored in a memory. Information related to a selected column corresponding to a divisor/root estimate is stored in a high-speed memory. Division/root computation is performed iteratively using the cached information to improve access times and reduce latency of accessing the entire lookup table on each iteration. In each iteration, a quotient/root is determined from the cached information based on a current partial remainder, and a next partial remainder is generated based on the quotient/root, the divisor/root estimate, and the current partial remainder. implementations of the technology described herein are directed to mechanisms for quickly calculating floating-point divides and square roots in a processor.

For example, an exemplary aspect relates to a method of performing a division, the method comprising, selecting a column of a lookup table according to a Sweeney, Robertson, and Tocher (SRT) algorithm for the division, the selected column corresponding to a divisor of the division and caching information related to the selected column in a high-speed memory. The method includes iteratively performing the division using the cached information, by determining a quotient from the cached information using a current partial remainder in each iteration, and generating a next partial remainder based on the quotient, the divisor, and the current partial remainder.

Another exemplary aspect relates to a method of performing a root computation, the method comprising: selecting a column of a lookup table according to a Sweeney, Robertson, and Tocher (SRT) algorithm for the root computation, the selected column corresponding to a root estimate of the root computation and caching information related to the selected column in a high-speed memory. The method includes iteratively performing the root computation using the cached information, by determining a root from the cached information using a current partial remainder in each iteration, and generating a next partial remainder based on the root, the root estimate, and the current partial remainder.

Yet another exemplary aspect relates to a processor comprising a memory configured to store a lookup table according to a Sweeney, Robertson, and Tocher (SRT) algorithm for a division/root computation and a high-speed memory configured to cache information related to a selected column of the lookup table, the selected column corresponding to a divisor/root estimate. A division/root computation unit is configured to iteratively perform division/root computation using the cached information, comprising a division/root lookup logic configured to determine a quotient/root from the cached information based on a current partial remainder in each iteration, and generate a next partial remainder based on the quotient/root, the divisor/root estimate, and the current partial remainder.

Another exemplary aspect relates to a processing system comprising means for storing a lookup table according to a Sweeney, Robertson, and Tocher (SRT) algorithm for a division/root computation and caching means for caching information related to a selected column of the lookup table, the selected column corresponding to a divisor/root estimate. The processing system includes means for iteratively performing division/root computation using the cached information based on means for determining a quotient/root from the cached information using a current partial remainder in each iteration, and means for generating a next partial remainder using the quotient/root, the divisor/root estimate, and the current partial remainder.

### BRIEF DESCRIPTION OF THE DRAWINGS

The accompanying drawings are presented to aid in the description of the technology described herein and are provided solely for illustration of the implementations and not for limitation of the implementations.

FIG. 1 is a high-level block diagram of a computer system according to one or more implementations of the technology described herein.

FIG. 2 is a block diagram of a computer system according to one or more implementations of the technology described herein

FIG. 3 is a schematic diagram of a lookup table according to the SRT algorithm utilized in one or more implementations of the technology described herein.

FIG. 4 is a block diagram of a division and square root unit according to one or more implementations of the technology described herein.

FIG. 5 is a flowchart illustrating a method of performing divisions and square roots in a processor according to one or more implementations of the technology described herein.

FIG. 6 is a flowchart illustrating another method of performing divisions and square roots in a processor according to one or more implementations of the technology described herein.

FIGS. 7A-C illustrate aspects of a high performance division and square root unit suitable for implementing the method depicted in FIG. 6.

FIGS. 8A-C illustrate aspects of another high performance division and square root unit suitable for implementing the method depicted in FIG. 6.

FIG. 9 is a block diagram of lookup logic according to one or more implementations described herein.

FIG. 10 is a block diagram showing an exemplary wireless communication system in which a division/root computation unit according to exemplary aspects described herein may be employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to high performance implementations of division and root computation (e.g., square root, cube root, etc.). In some aspects, an exemplary division and square root unit is configured to speed up and simplify the complexity of conventional implementations of the SRT algorithm. A lookup table according to a Sweeney, Robertson, and Tocher (SRT) algorithm for a division/root computation is stored in a memory. The table lookup process in each iteration of the SRT algorithm may be simplified, based, for example on determining a subset of the lookup table comprising one or more table entries of the lookup table which will be accessed for a particular division or root computation implemented in an exemplary processor. In the case of division, the subset may include table entries of a selected column corresponding to the divisor of the particular division. It is recognized that the divisor will be common to each iteration of the SRT algorithm, and therefore, the selected column comprising various possible quotient values corresponding to the various possible partial remainder values for that particular divisor can be extracted from a comprehensive lookup table which has these values for other divisor values. In exemplary aspects, the extracted selected column can be placed in a simplified one-dimensional memory structure which can be more simply indexed with the partial remainder in each iteration (as opposed to indexing the two-dimensional lookup table with two indices as in conventional implementations). The one-dimensional memory structure can be implemented in several ways. Regardless of the particular implementation, the one-dimensional memory structure can be cached in a high-speed memory and accessed with improved speed for the numerous iterations involved in a particular division. Since storage, indexing, and accessing of the one-dimensional memory structure is simpler than a two-dimensional lookup table, power consumption in each iteration is also reduced.

Extraction and storage of the selected column for a particular divisor can be implemented in several ways. In some aspects, a column mask may be applied to the two-dimensional table in order to extract the selected column corresponding to a specific divisor value for a particular division operation. Alternatively, the selected column may be directly accessed. Extraction of the selected column will be further explained with reference to the various exemplary aspects of this disclosure. Once extracted, the selected column can be stored in a high-speed memory which can be configured to support a one-dimensional memory structure. For example, the high speed memory may be an on-chip cache which is integrated on the same chip as a processor comprising an arithmetic and logic unit (ALU) or more specifically, a floating point unit (FPU) which may be utilized for division and root computations. At the start of an exemplary division, the dividend and divisor operands may be read (e.g., from a register file, cache, main memory, etc.) and a table lookup may be performed to a main or comprehensive two-dimensional lookup table. A selected column can be extracted using the divisor operand and placed in the high speed memory. Entries of the high speed memory can then be accessed in each iteration of the division.

While the above aspects relate to a table lookup for determining quotient bits corresponding to particular mappings of combinations of the partial remainder and the divisor, alternative implementations are possible, where the same mapping can be obtained from logical expressions. For example, for each divisor value, the quotient value for a particular partial remainder value may be expressed as a Boolean or logical expression using bits of the partial remainder value and predetermined coefficients. Since more than one partial remainder may map to the same quotient value for a particular divisor, the logical expressions are formulated to exploit the repetition in the mappings. In exemplary aspects, the logical expressions (or more specifically, coefficient values) that can be used to derive the quotient values for the specific divisor value and various possible partial remainder values can be determined and used for the various iterations involving the same specific divisor value.

It will be understood that in exemplary implementations, fewer than all bits of the divisor and/or the partial divisor (e.g., predetermined numbers of MSBs) may be utilized in the various table lookup operations and/or representations of mapping to quotient values using logical expressions.

Aspects related to root computation (e.g., square root) are not described in the same level of detail as division in this disclosure. This is because the various exemplary aspects discussed for division can be easily extended to root computation. For example, where references to a particular divisor are made with regard to table lookups for a particular division operation implemented using the SRT algorithm, an estimate of the root may be used instead, for the case of root computations using the SRT algorithm. Thus, a column of a similar lookup table for a root computation may be selected using an initial estimate of a root, where the initial estimate may be derived from a different lookup table or other mechanisms known in the art. For the purposes of this disclosure, the remaining processes are similar when it comes to a root computation.

Accordingly, an exemplary processor is described which includes a division/root computation unit. A memory is configured to store a lookup table according to a Sweeney, Robertson, and Tocher (SRT) algorithm for a division/root computation and a high-speed memory is configured to cache information related to a selected column of the lookup table, the selected column corresponding to a divisor/root estimate. The division/root computation unit is configured to iteratively perform division/root computation using the cached information. The cached information can include all quotient/root values for the divisor/root estimate in the selected column of the lookup table. In some aspects, the cached information comprises quotient/root select masks based on a logical combination of the divisor/root estimate for the selected column of the lookup table.

Iteratively performing the division/root computation involves a division/root lookup logic configured to determine a quotient/root from the cached information based on a current partial remainder in each iteration and to generate a next partial remainder based on the quotient/root, the divisor/root estimate, and the current partial remainder. the current partial remainder for a first iteration is the dividend/radicand for the division/square root.

In some implementations, the division/root lookup includes hardware such as a multiple select multiplexer to select a multiple of the divisor estimate based on the quotient/root, and a partial remainder subtractor to generate a next partial remainder as the multiple of the divisor/root subtracted from the current partial remainder. The division/root lookup logic may be configured to determine the quotient/root from the cached information based on only a preselected number of most significant bits (MSBs) of the current partial remainder in each iteration. A carry-propagate adder (CPA) may be configured to add only the most significant bits of a pair of redundant partial remainders from a previous iteration. A pair of redundant partial remainder registers may store the next partial remainder in a redundant form. Moreover, one or more quotient registers, such as a pair of registers comprising a developed quotient/root register (Q) and a developed quotient/root minus one register (Q−1) may be used to store the quotient/root in each iteration.

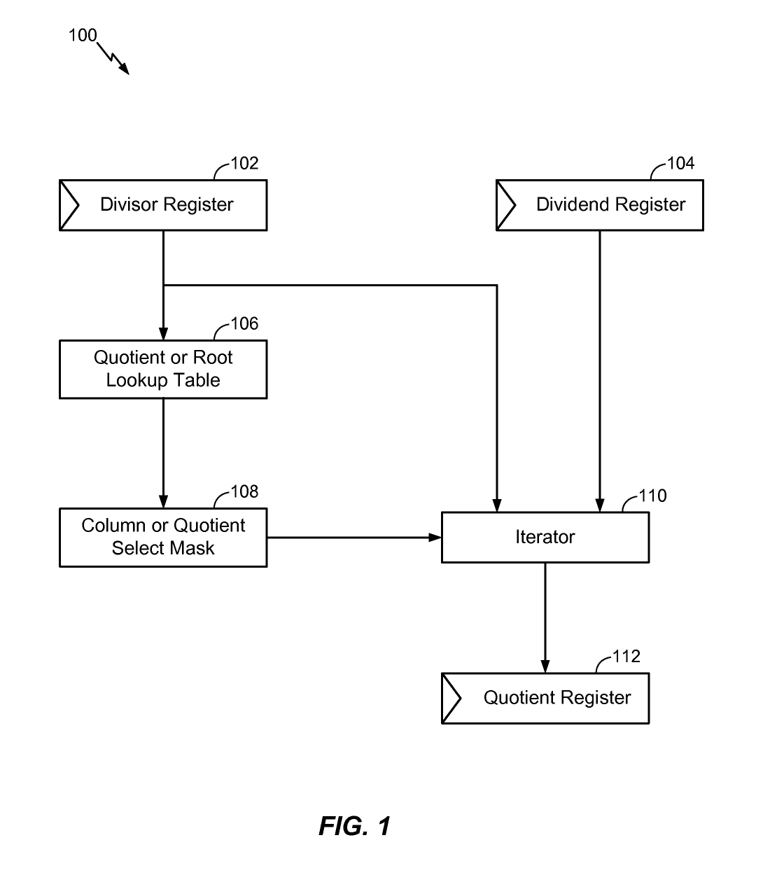

With reference now to FIG. 1, a high-level overview of processor 100 configured to implement exemplary division and/or root computation operations, is illustrated. In the case of division, a dividend and a divisor operands may be received and stored in dividend register 104 and divisor register 102, respectively. Quotient/root lookup table 106 includes a memory structure which comprises a two-dimensional array with combinations of partial remainder values and divisor values mapped to (or tabulated to indicate) corresponding quotient values. As previously mentioned, fewer than all bits (e.g., a predetermined number of MSBs) of the partial remainder values and/or the divisor values may be used in quotient or root lookup table 106. Accordingly, bits of the divisor from divisor register 102 may be used to select a corresponding column of quotient or root lookup table 106. The selected column or the selected quotients may be extracted from quotient/root lookup table 106. Column/quotient select mask 108 may include masking functions or logic to extract the selected column or the selected quotients from quotient/root lookup table 106.

The selected column or selected quotients available at the output of column/quotient select mask 108 may be latched or directly fed to iterator 110. Dividend register 104 provides the dividend to iterator 110. Iterator 110 may include logic to perform computation for division/root computation in each iteration of a corresponding SRT algorithm. For example, iterator 110 may produce one or more (e.g., r) bits per iteration based on the radix and particular values of the dividend and divisor. Each iteration may be pipelined and executed over one or more clock cycles of processor 100 depending on particular implementations. Once column/quotient select mask 108 is produced, it remains constant across all iterations. In each iteration, the r bits of the result (quotient/root) are produced, which may be stored in one or more registers such as quotient register 112. In each iteration, the bits stored in quotient register may be shifted left to make room for bits in subsequent iterations and follow the correct order of bits of the results. Once the computation is completed (e.g., as determined by a partial remainder value of zero or when a predetermined maximum number of iterations/predetermined precision is reached), e.g., after n iterations the result may be available from quotient register 112. Further, after the first iteration, dividend register 104 is replaced with the partial remainder, and after each subsequent iteration, the partial remainder obtained at the end of that iteration is stored in dividend register 104.

As described above, the Sweeney, Robertson, and Tocher (SRT) algorithm may include a two-dimensional mapping of partial remainder and divisor values to a quotient, which may be in the form of a lookup table. For example, in the lookup table, m MSBs of a partial remainder in a particular iteration and n MSBs of the divisor 102 (in the case of division) or the root estimate (in the case of performing a square root operation) may be used to index into the lookup table to provide b bits of a quotient for that iteration. The particular lookup table used depends on various design considerations, such as the integers m, n, and b, and other parameters such as the radix and the accuracy of the partial remainder/root estimate. In some cases, the partial remainder may not be fully resolved or computed in each iteration. As will be explained in the following sections, it may be possible to leave the computation of a partial remainder in a redundant form (e.g., comprising sum and carry components, rather than a resolved or non-redundant form which would be obtained after adding the sum and carry components in a carry-propagate adder (CPA) as known in the art). If the partial remainder is in redundant form and only m MSBs of the partial remainder are used, then only the m MSBs of the carry and sum components may be resolved in order to get an estimate of the partial remainder in each iteration, rather than resolve the partial remainder first and obtain the m MSBs of the resolved result. Thus, the partial remainder estimate may assume either a carry-in of “0” or “1” from the resolution of less significant bits of the carry and sum components. The precision of the quotient obtained in each iteration is correspondingly adjusted based on the correctness of these assumptions.

A particular iteration of the SRT algorithm will now be discussed in further detail. For example, the operation in an i^{th} iteration can be represented by the equation: Pᵢ₊₁=r*P₁−qᵢ₊₁*D. In this equation, Pᵢ is the partial remainder available as an input to the i^{th} iteration and Pᵢ₊₁ is the partial remainder obtained at the end of the i^{th} iteration, to be used in the next or (i+1)^{th} iteration. D represents the divisor, r is the radix, and qᵢ₊₁ represents b bits of the quotient that are provided by the lookup table. The next partial remainder becomes the previous partial remainder in a next iteration on the index i, where the lookup table is accessed again but with an approximation of Pᵢ₊₁ to provide the next b bits of the quotient. For the first iteration, the dividend is used as the input partial remainder.

The SRT algorithm may also be used in an iterative fashion to perform a root computation. In the case of performing a square root operation, for example, an initial estimate of the square root is used, which may be provided by another lookup table. Given divisor 102 or an initial estimate of a square root, one implementation caches a column of a lookup table. The cached column is based upon the divisor 102 or initial estimate of the square root. The cached column is accessed each iteration of the SRT algorithm.

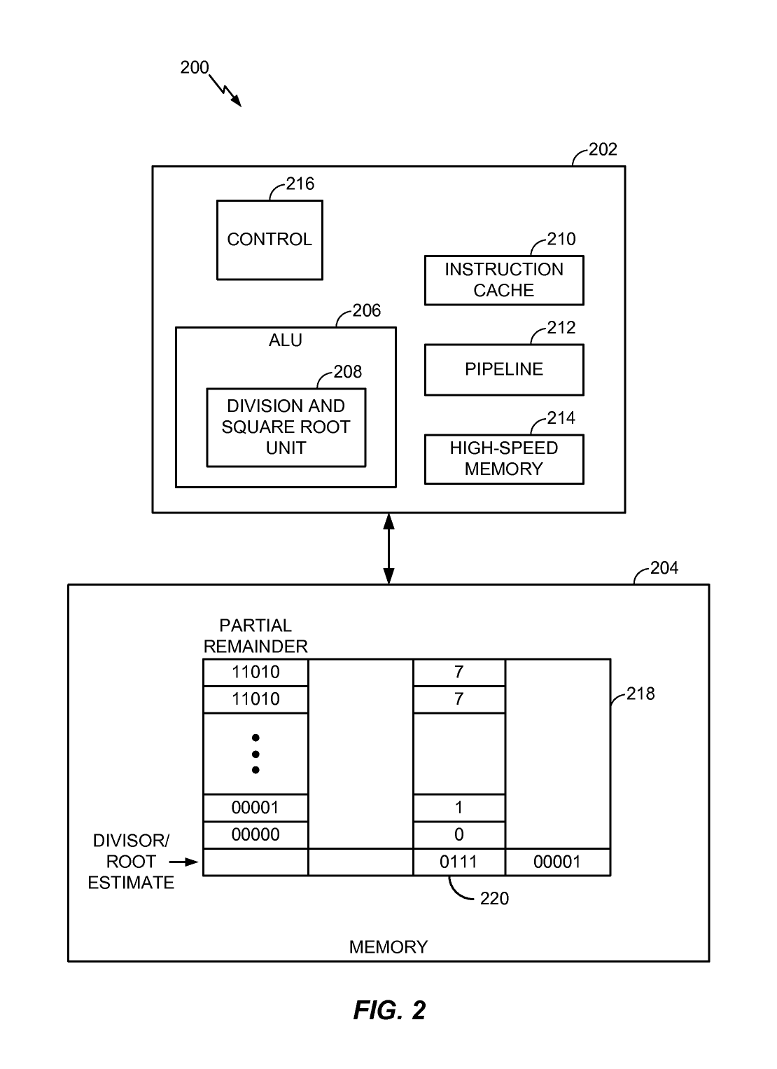

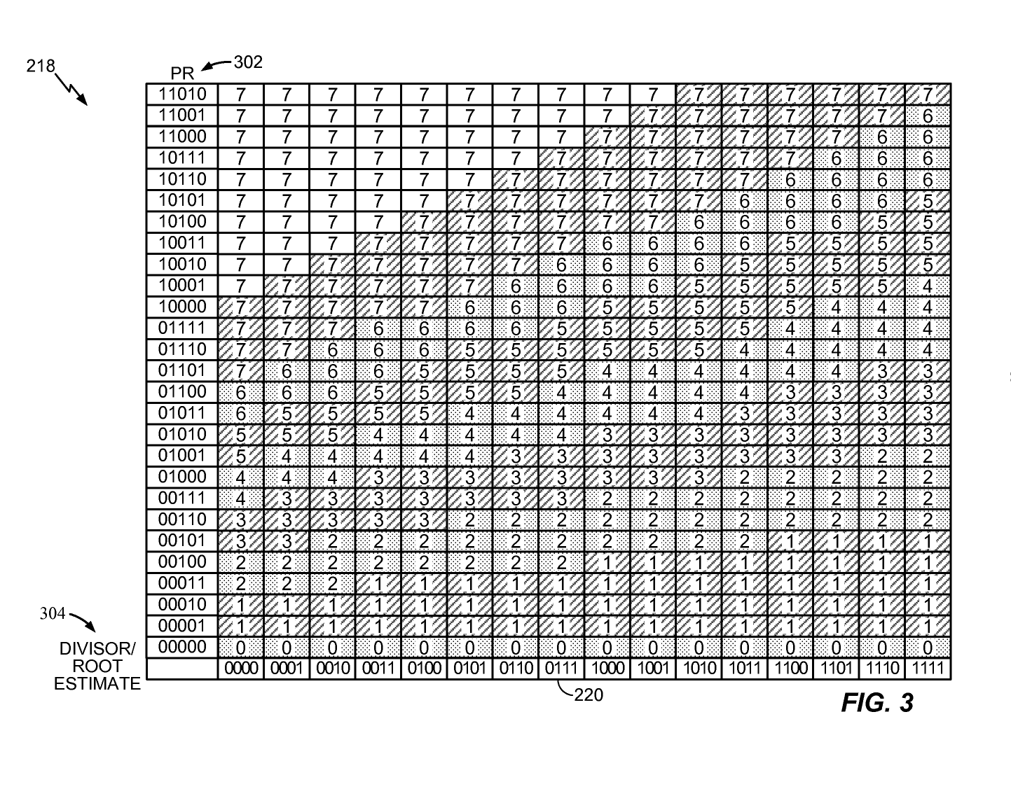

FIG. 2 is a high-level block diagram of computer system 200 configured according to one or more implementations described herein. The illustrated computer system 200 includes processor 202 and memory 204. Processor 202 includes arithmetic logic unit (ALU) 206, division and root computation unit 208, instruction cache 210, pipeline 212, high-speed memory 214, and control unit 216. Memory 204 includes partial remainder/root table 218, which is a two-dimensional table or array which requires indexing using at least two indices, such as bits of a divisor/root estimate (x-axis) and bits of a partial remainder (y-axis). In FIG. 2, only a partial view of partial remainder/root table 218 is shown, while FIG. 3 illustrates an expanded/complete view of partial remainder/root table 218. For division, the quotient values corresponding to each combination of x and y indices are provided in partial remainder/root table 218. For root computation, roots for future iterations are provided in place of quotient values. As previously mentioned, the detailed description of exemplary aspects will focus on division. As such, in the case of division, the quotient values are shown in decimal notation (for ease of illustration), whereas the x and y indices are shown in binary notation.

In some aspects, computer system 200 may be configured in or form part of a cellular phone, a tablet, a phablet, a personal digital assistant, or other user device. Processor 202 may be a general-purpose processor, a microcontroller, multicore processor, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

In some aspects, memory 204 may be a memory structure (e.g., a cache, register bank, etc.) or any other means for storing a lookup table, which may be in communication with processor 202. ALU 206 can perform arithmetic and logical operations on data. Division and root computation unit 208 can perform division and root computation operations. Instruction cache 210 may be populated with instructions of various instruction types that may be retrieved, for example, from a higher order cache or memory. Control unit 216 may provide control to pipeline 212 and other functional units (not shown) within processor 202. High-speed memory 214 may be viewed as and referred to as a cache, a caching means, or a register bank. High-speed memory 214 may be located or integrated on the same chip as processor 202 for faster access, and may also be referred to as an on-chip cache in this context. Although high-speed memory 214 has been illustrated as an individual block, there is no requirement for high-speed memory 214 to be a standalone structure; on the other hand, high-speed memory 214 may be integrated or be part of any other memory structure, which in exemplary aspects is integrated on the same chip as processor 202.

As previously discussed, in one exemplary aspect, a one-dimensional array or column of partial remainder/root table 218 can be extracted and cached for quick access and easier indexing than the entire two-dimensional partial remainder/root table 218. Extraction of the one-dimensional array or column may be implemented in several ways including directly reading out the column, using a mask to read out the column, etc., as will be discussed in the following sections in further detail.

The rows of partial remainder/root table 218 are indexed by the approximate partial remainder, where the values 00000, 00001, 11001, and 11010 are explicitly shown. The columns are indexed by the divisor (or a truncated version, e.g., comprising MSBs of the divisor) in the case of division or the root estimate (or a truncated version of the root estimate) in the case of root computation. A truncated divisor may include the n MSBs of the divisor (excepting the MSB, which is always “1” in a normalized floating point notation), where n is chosen according to established rules regarding the number of bits produced by the look-up table.

A selected column 220 of partial remainder/root table 218 is particularly shown in FIG. 2, corresponding to the divisor value 0111 (in the floating point normalized format, the divisor value is actually 1.0111). In the particular example of FIG. 2, processor 202 is configured to perform a division (or root computation) with a truncated divisor (or root estimate) corresponding to the value 0111. Accordingly, one implementation loads selected column 220 of partial remainder/root table 218 into an on-chip cache such as high-speed memory 214. Once loaded, execution units of pipeline 212 may have quick access to selected column 220, which may be indexed by the partial remainder alone in each iteration of executing the division or root computation using the SRT algorithm, for example.

FIG. 3 illustrates an expanded view of the partial remainder/root table 218 according to an example. As shown in FIG. 3, partial remainder/root table 218 includes a first index or y-index 302 comprising partial remainders (e.g., only the preselected number of MSBs) and a second index or x-index 304 comprising divisor or root estimate values (e.g., only the only the preselected number of MSBs). Specifically for the illustrated example of division, corresponding quotient values for each combination of x and y indices are shown in decimal notation, as previously noted. For example, selected column 220 corresponding to divisor value 0111 includes quotient values ranging from decimal numbers 0-7 for various partial remainder values ranging from 00000 to 11010. Selected column 220 may be cached in exemplary aspects for a particular division or root computation and accessed in an expedited manner.

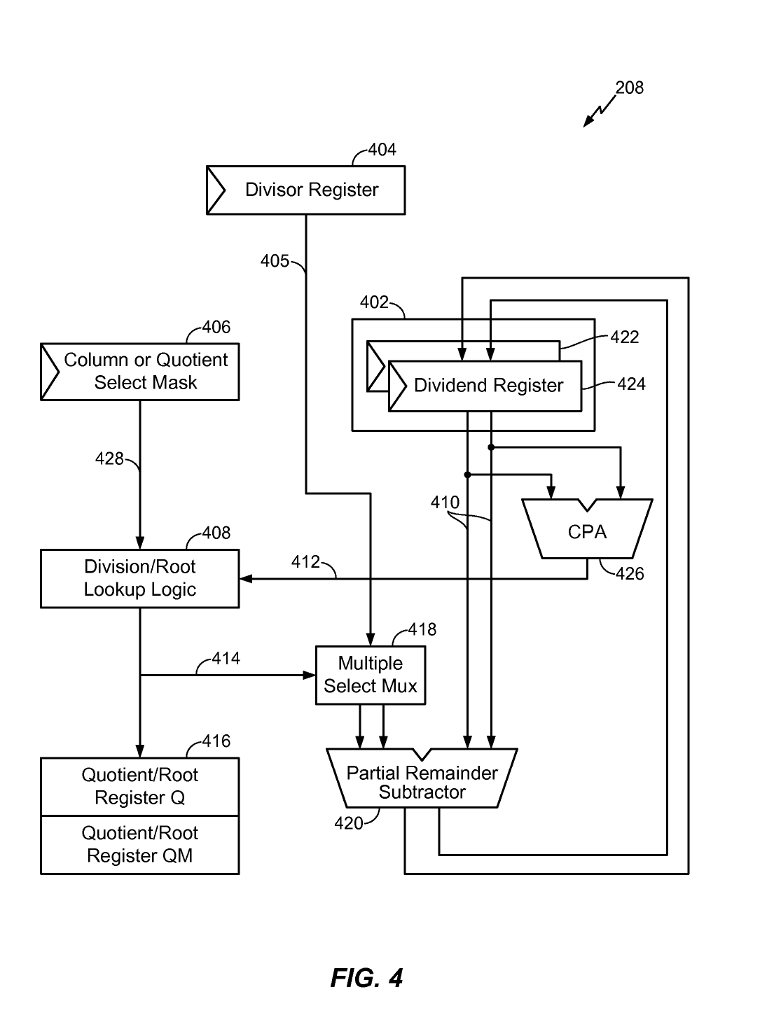

FIG. 4 is a schematic diagram of illustrating aspects of a division/root computation unit or other means for iteratively performing division/root computation, such as division and root computation unit 208 according to one or more implementations of an SRT algorithm is illustrated. In FIG. 4, division and root computation unit 208 is described primarily for the case a division, while root computation is similar. Selected column 220 corresponding to a divisor/root estimate may be cached and used in the various iterations of an SRT algorithm to determine a quotient/root from the cached information based on a current partial remainder in each iteration, and used to generate a next partial remainder based on the quotient/root, the divisor/root estimate, and the current partial remainder in each iteration. Selected column 220 may be directly read from partial remainder/root table 218 or extracted from partial remainder/root table 218 using a quotient selection mask. Column or quotient select mask 406 may be another depiction of high-speed memory 214 or may be derived from high-speed memory 214, as the case may be.

It is noted that column or quotient select mask 406, divisor register 404, dividend/partial remainder registers 402, and quotient/root registers 416 may be memory structures which may be located outside division and root computation unit 208 in some implementations, and may also be shared with other components or blocks of processor 200. However, in FIG. 4, these memory structures are depicted in the illustration of division and root computation unit 208 to show their interaction with the remaining blocks of division and root computation unit 208. With this mind, division and root computation unit 208 is shown to include dividend registers 402, divisor register 404, divisor bits 405, column or quotient select mask 406, column or quotient select mask bits 428, division/root lookup logic 408, redundant dividend/partial remainder bits 410, resolved partial remainder bits 412, quotient/root bits 414, quotient/root registers 416, selector or multiple select multiplexer 418, partial remainder subtractor 420, and carry-propagate adder (CPA) 426. Dividend/partial remainder registers 402 are shown to include first and second redundant partial remainder registers 422 and 424 which make up which partial remainder 402 when they are resolved or added together into a non-redundant form using CPA 426, for example.

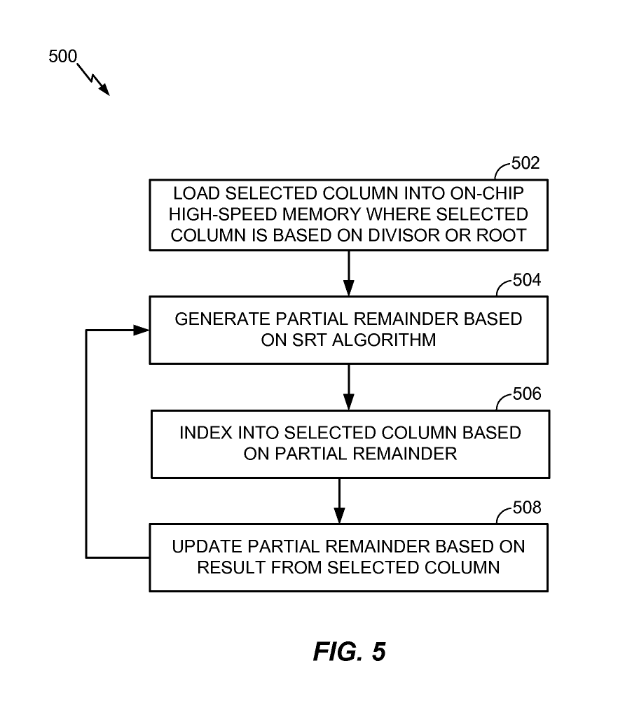

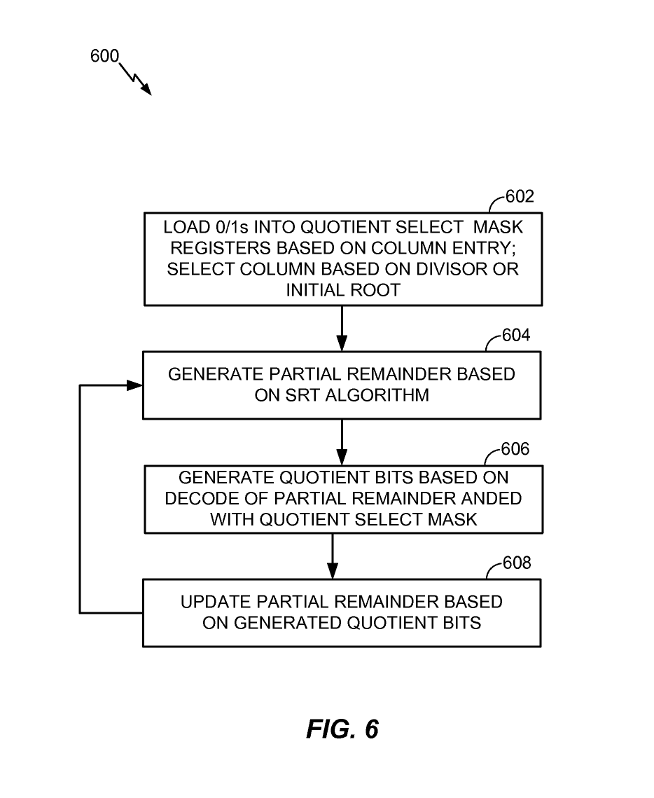

For an exemplary division operation (e.g., based on the SRT algorithm) performed using division and root computation unit 208, dividend and divisor operands may be received from an instruction and loaded into dividend registers 402 and divisor register 404, respectively. As previously described, a column (e.g., 220) can be selected from partial remainder/root table 218 based on bits of the divisor from divisor register 404. Selecting this column, or “pre-selection” may be accomplished directly or by forming a mask. Information related to the selected column can be cached in used in the various iterations of the SRT algorithm. The cached information can include the values in the column or combinational logic such as a quotient select mask that can be used to obtain the values in the column Aspects where the cached information includes all quotient/root values for the divisor/root estimate in the selected column of the lookup table will be discussed with relation to FIG. 5. Aspects where the cached information includes combinational logic such as quotient/root select masks based on a logical combination of the divisor/root estimate for the selected column of the lookup table will be discussed further with relation to FIG. 6.

Thus, column or quotient select mask 406 can include either selected column 220 (as in FIG. 5) extracted from partial remainder/root table 218 or a quotient select mask (as in FIG. 6) which will be used to obtain the quotients of selected column 220. Column or quotient select mask 406 is accordingly loaded with the cached information comprising selected column 220 or the quotient select mask, prior to the start of the first iteration. Means for determining a quotient/root from the cached information using a current partial remainder in each iteration are used in conjunction with means for generating a next partial remainder using the quotient/root, the divisor/root estimate, and the current partial remainder. For example, a division/root lookup logic is configured to determine a quotient/root from the cached information based on a current partial remainder in each iteration, and generate a next partial remainder based on the quotient/root, the divisor/root estimate, and the current partial remainder. In the illustrated implementation, division/root lookup logic 408 includes logic to lookup either selected column 220 from if the cached information comprises selected column 220 or lookup quotient bits using the quotient select mask if the cached information comprises quotient select mask to obtain quotient values of selected column 220. Division/root lookup logic 408 may lookup the selected column or quotient select mask using next partial remainder bits 412 (e.g., y-index) in each iteration, and more specifically, truncated and possibly approximate resolved partial remainder bits 412.

Regardless of whether the selected column is extracted or quotient select mask bits are used in block 406, the remaining blocks of division and root computation unit 208 will now be explained. For the first iteration, dividend registers 402 hold the dividend. After the first iteration, for each subsequent iteration, dividend registers 402 hold redundant partial remainders in first and second redundant partial remainder registers 422 and 424, which produce redundant partial remainder bits 410 during each iteration. The redundant partial remainder bits 410 may be in sum/carry, redundant binary signed digit (RBSD) or any other redundant number format.

Divisor register 404 holds divisor bits 405. Redundant partial remainder bits 410 are output from the first and second redundant dividend registers 402, which are then input into CPA 426. As previously stated, only a truncated version of the redundant partial remainder bits may be added (e.g., a few MSBs) in order to save time. Accordingly, CPA 426 may add MSBs of redundant partial remainder bits 410 and outputs non-redundant or resolved partial remainder bits 412. The number of MSBs of redundant partial remainder bits 410 to be added in CPA 426 may be dependent upon the number of bits processed per cycle. As previously mentioned, resolved partial remainder bits 412 is used as an index by division/root lookup logic 408 to lookup the quotient or root from column or quotient select mask 406.

Division/root lookup logic 408 can then obtain quotient bits 414, which may be stored in quotient/root register 416 for each iteration. In general, a multiple select multiplexer may be used to select a multiple of the divisor/root estimate based on the quotient/root. In the illustrated implementation, quotient bits 414 for each iteration may also be used by multiple select mux 418, which selects the multiple of the divisor bits 405 that is to be subtracted from the redundant partial remainder bits 410. For example, if the quotient bits 414 denote a decimal value of “3,” then multiple select mux 418 selects “3” times the divisor bits 405 and outputs this value to partial remainder subtractor 420.

A partial remainder subtractor may then be used to generate a next partial remainder as the multiple of the divisor/root estimate subtracted from the current partial remainder. As shown, subtractor 420 calculates the difference between partial remainder bits 410 (from a previous iteration) and the multiple of divisor bits 405 to obtain the partial remainder for the next iteration, to be stored in first and second redundant partial remainder registers 422 and 424 after a left shift, as follows. The partial remainder for the next iteration is shifted left based on how many quotient bits 414 are produced (e.g., based on the radix). Thus, if three quotient bits 414 are produced, the redundant partial remainder bits for the next iteration are shifted left three bits and loaded into first and second redundant partial remainder registers 422 and 424.

Division/root lookup logic 408 obtains the shifted difference from first and second redundant partial remainder registers 422 and 424 in the next iteration and the process repeats. That is, division and root computation unit 208 repeats the process of reading the divisor bits 405, selecting the multiple of the divisor bits 405, and performing the subtraction of the multiple of the divisor bits 405 from the redundant partial remainder bits 410.

While quotient register 416 may be a single register (e.g., quotient register Q 430), in some implementations, quotient register 416 may comprise one or more quotient registers such as a pair of registers comprising a developed quotient/root register (Q) and a developed quotient/root minus one register (Q−1) to store the quotient/root. For example, as shown, quotient register Q 430, holds the developed quotient value Q, and quotient register QM 434, holds the developed quotient minus one value Q−1. Updating of these quotient registers 416 can be performed using on-the-fly algorithms, as known in the art.

It will be appreciated that aspects include various methods for performing the processes, functions and/or algorithms disclosed herein. For example, FIG. 5 is a flowchart of method 500 for operating division and root computation unit 208 in which a column from the partial remainder/root table 218 is selected and used for looking up the quotient. Prior to start of method 500, partial remainder/root table 218 for the SRT algorithm for a given radix and accuracy is generated and stored in memory 204.

In block 502, method 500 loads a column of the lookup table into on-chip high speed memory. For example, given a divisor or root estimate, an appropriate column (e.g., 220) from the partial remainder/root table 218 is selected and stored in on-chip, high-speed memory 214 of FIG. 2. In the view of division and root computation unit 208 shown in FIG. 4, column or quotient select mask 406 is another depiction of high-speed memory 214 or is derived from high-speed memory 214. In FIG. 5, column or quotient select mask 406 holds the selected column.

Method 500 flows from blocks 504 to 508 for each iteration of the SRT algorithm. After block 508 for a current iteration, method 500 proceeds via path 510 to block 504 and repeats until a partial remainder of zero or desired accuracy are achieved.

In block 504, method 500 generates a partial remainder based on the SRT algorithm. It is noted that for the first iteration, the first or initial partial remainder may be the dividend or radicand.

In block 506, method 500 indexes into the selected column based on the partial remainder. For example, partial remainder bits generated by the SRT algorithm in a particular iteration may be used to index into the selected column of partial remainder/root table 218 stored in the high-speed memory 214 or column or quotient select mask 406 to provide the estimated quotient bits or square root bits. In further detail, referring back to FIG. 4, division/root lookup logic 408 uses resolved partial remainder bits 412 and to index column or quotient select mask 406 and obtain the quotient bits 414.

In block 508, method 500 updates the partial remainder based on the quotient from the selected column. In one or more implementations, the quotient bits 414 are used to select a multiple of the divisor or root formed thus far, which is subtracted from the current partial remainder bits in a particular iteration to produce partial remainder bits of the next iteration. In further detail, quotient bits 414 obtained from division/root lookup logic 408 may be used to obtain a multiple of divisor bits 405 using multiple select mux 418, which may be subtracted from redundant partial remainder bits 410 in subtractor 420 to produce partial remainder bits to be stored in first and second partial remainder registers 422 and 424 for the next iteration.

After method 500 updates the partial remainder based on the result from the selected column, method 500 returns to block 504 through path 510 and repeats from that point for the next iteration.

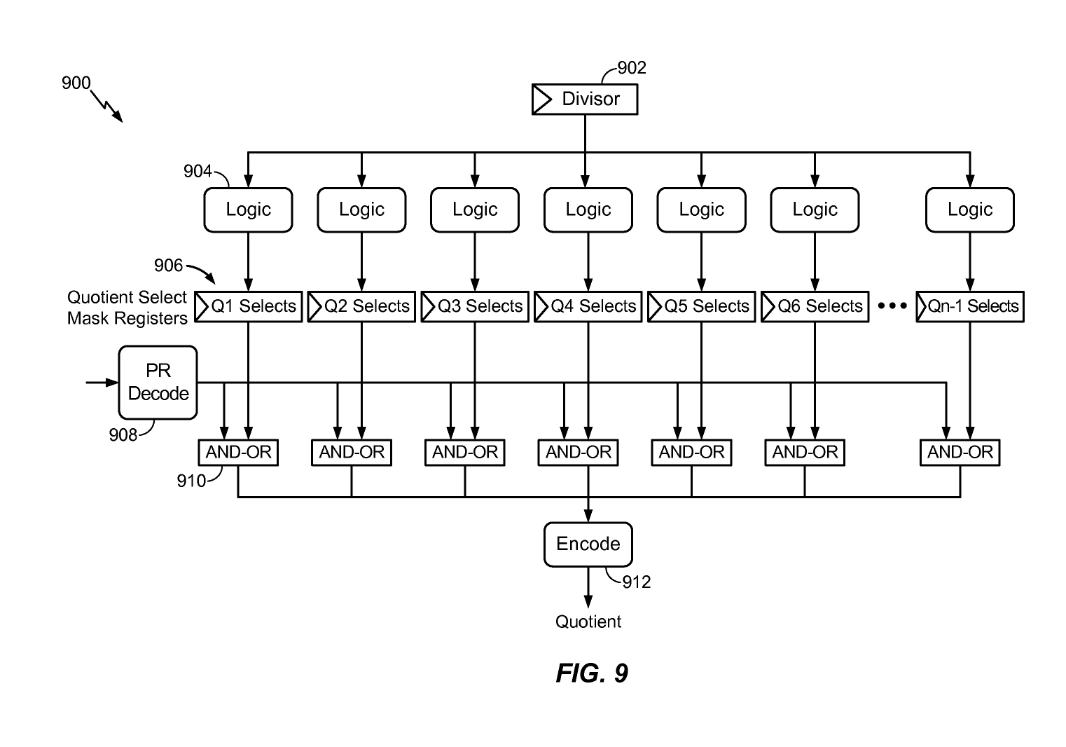

With reference now to FIG. 6 a flowchart of another method 600 of operating division and root computation unit 208, according to one or more alternative implementations, is illustrated. In method 600, a selected column of partial remainder/root table 218 based upon a divisor or root estimate (or a truncated version thereof) may be effectively recoded as a logical expression to control combinational logic. The combinational logic provides the next quotient bits (i.e., result of a particular iteration) as a function of the current partial remainder. The combinational logic is referred to as the quotient select mask in the above descriptions. The combinational logic may be cached rather than the selected columns comprising the quotient values as in method 500 of FIG. 5. The cached combinational logic is used by division/root lookup logic 408 of FIG. 4, for example, to output the quotient bits 416 based on the resolved partial remainder 412. In cases where the partial remainder is truncated, the combinational logic will be based on an approximation of the partial remainder, as previously explained. Example combinational logic suitable for executing method 600 is described with reference to FIG. 9 below.

Like method 500, prior to start of method 600, partial remainder/root table 218 for the SRT algorithm for a given radix and accuracy is generated and stored in memory 204.

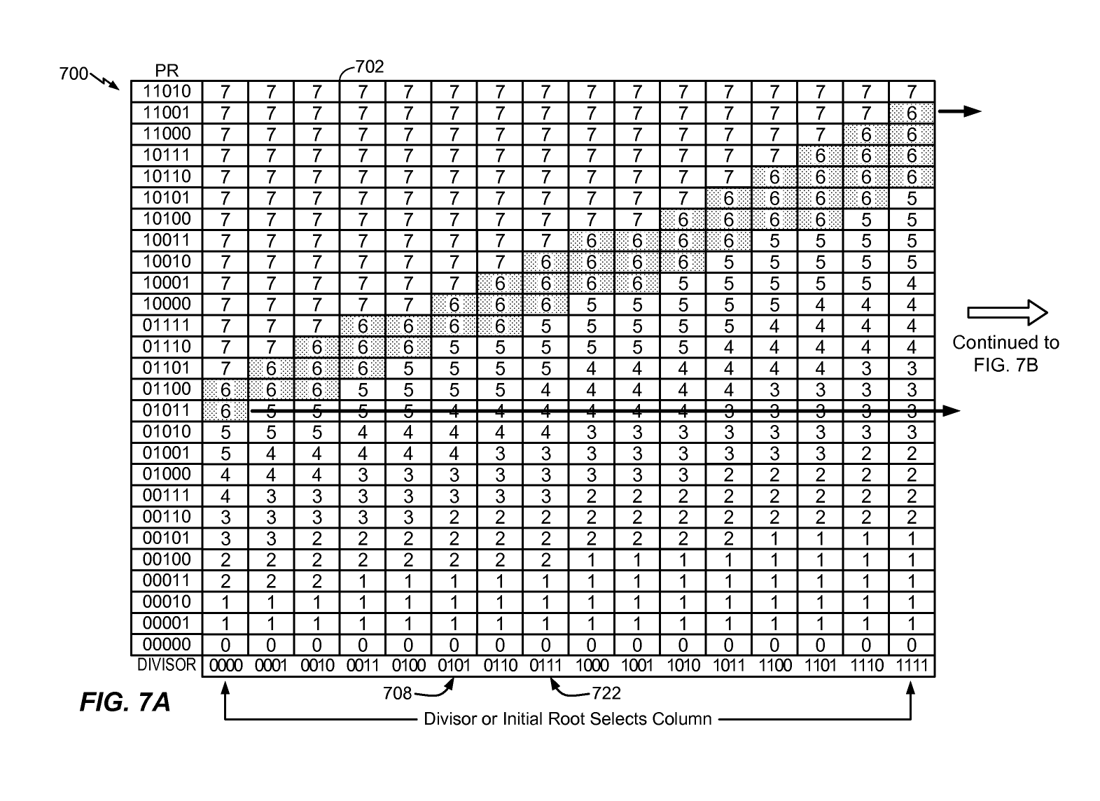

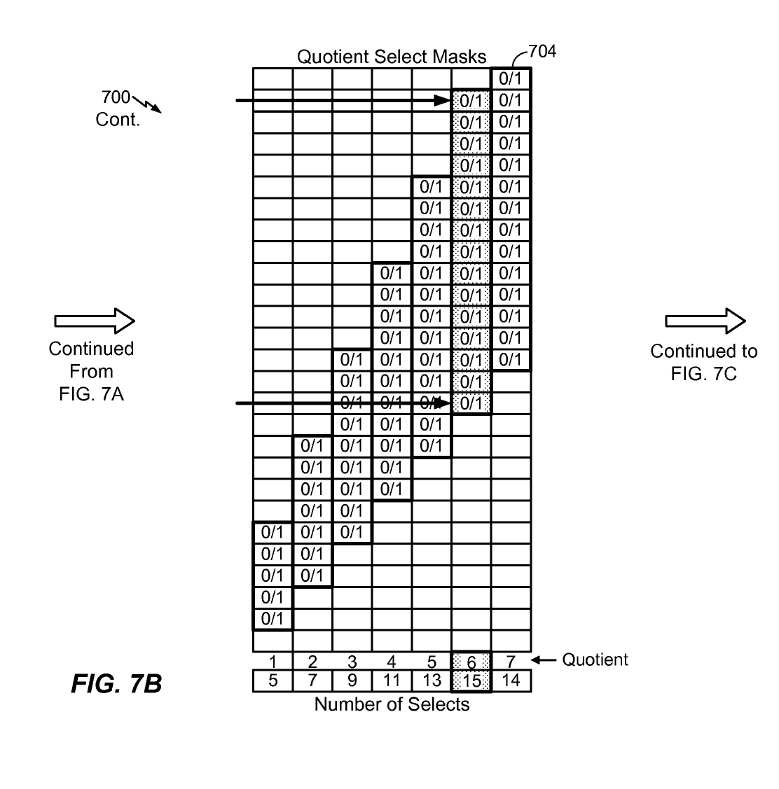

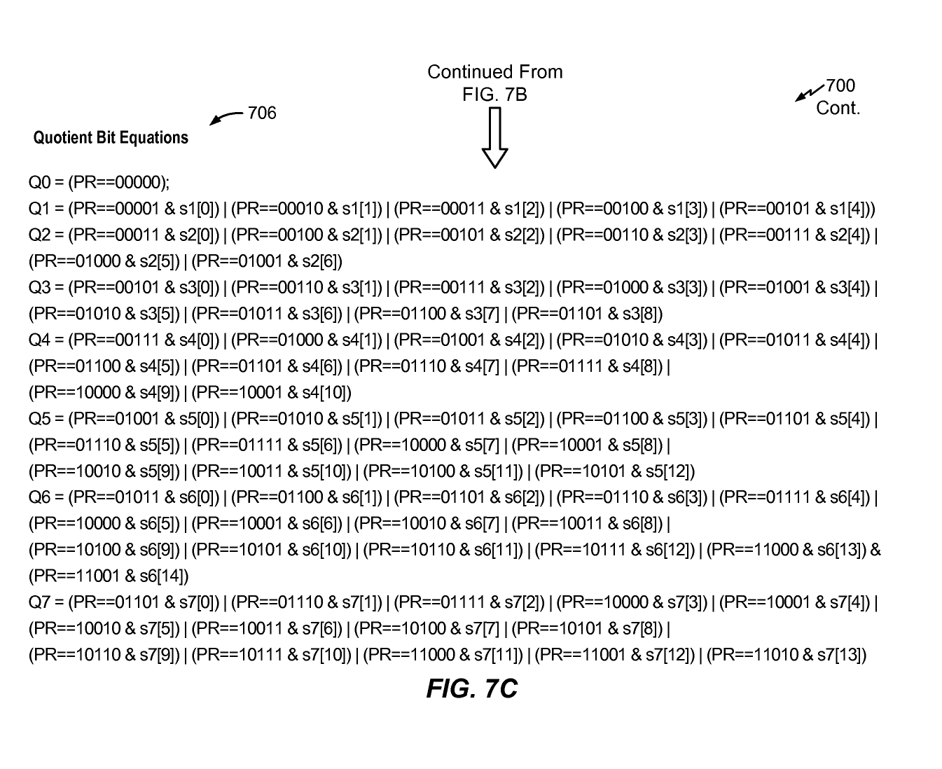

In block 602, method 600 loads “0s” and 1s” into quotient select mask registers based on a selected column 220, which is selected based on the divisor or root estimate. For example, the partial remainder is provided as input to combinational logic which includes up to (n−1) quotient/root select registers where n is equal to 2̂(radix), and where the radix is an indication of the number of bits of the quotient/root. For example, (n−1) quotient select registers may include patterns of “0”s and “1”s stored therein. The logical combination or combinational logic comprises comparators for comparing one or more bits of the current partial remainder with preselected partial remainder constants, and performing a logical AND on a result of the comparison with the quotient select registers. These aspects are explained further with reference to alternative implementations of partial remainder/root table 218, shown in FIGS. 7A-C and 8A-C. With a brief reference to FIGS. 7A-C, the number of bits in each quotient select register is equal to the total number of rows in table 702, for example. A “1” may be inserted into a bit of a quotient select mask register whenever the partial remainder in the selected column of the table matches the quotient select register number. If there is no match, then a “0” is inserted into the corresponding bit position.

Method 600 flows from blocks 604 to 608 for each iteration of the SRT algorithm. After block 608 for a current iteration, method 600 proceeds via path 610 to block 604 and repeats until a partial remainder of zero or desired accuracy are achieved.

In block 604, method 600 generates the partial remainder based on the SRT algorithm. It is noted that for the first iteration, the first or initial partial remainder may be the dividend or radicand.

In block 606, method 600 generates quotient bits based on decoding the partial remainder ANDed with a quotient select mask. In one implementation, the combinational logic compares the current partial remainder with preselected partial remainder constants or coefficients and the result of the compare is ANDed with the quotient select register number. These results are ORed together to form a “1-hot” decoded quotient. Also in block 608, the decoded quotient bits are encoded to produce a conventional binary representation of the quotient bits.

In block 608, method 600 updates the partial remainder based on the generated quotient bits. After the combinational logic provides the next quotient or root bits, method 600 returns to block 606 and repeats from there for subsequent iterations.

The combinational logic discussed with reference to method 600 may reside as a circuit on processor 102, where control unit 116 may provide the appropriate controls.

With reference now to FIGS. 7A-C and 8A-C, partial remainder/root tables 702 and 802, respectively, are illustrated. These partial remainder/root tables 702 and 802 are similar to partial remainder/root table 218 but their information is recast in different formats which are suitable for caching the selected column in terms of combinational logic or for implementing the quotient select mask previously described.

FIGS. 7A-C illustrate aspects of a high performance division and square root unit 700 suitable for implementing the method 600 according to exemplary aspects of this disclosure. Division and square root unit 700 includes table 702 (FIG. 7A), quotient select masks 704 (FIG. 7B), and quotient bit equations 706 (FIG. 7C). Table 702 includes divisor or root estimates 708 shown on the x-axis and partial remainders shown on the y-axis.

In the illustrated implementation, table 702 represents a radix-8 table lookup example, as each encoded quotient/root can have a value from 0-7. There are seven quotient select masks 704 which are numbered 1-7. Each bit in one of the seven quotient select mask 704 represents a “0” value or a “1” value, which is used as a mask to later select a decoded partial remainder.

The shaded entries in table 702 show an example that all table 702 quotient entries that correspond to a divisor value of 0111 or an equivalent decimal value “6” may be encoded into a quotient select mask #6. Each entry in the quotient select mask #6 is either a “0” or a “1” based on the column comprising divisor 0111, identified as column 722.

Division and square root unit 700 executes quotient bit equations 706. Quotient bit equations 706 represent the equations that generate a “1-hot” decoded quotient based on the partial remainder and the quotient select mask register bits set in the quotient select masks 704. As described above, these “1-hot” quotient bits can be encoded into a binary format by a conventional encoder.

Referring back to FIG. 4, information such as quotient select masks 704 can be cached or stored in the block, column or quotient select mask 406, rather than storing the entire column 422. Division/root lookup logic 408 can then use the 1-hot quotient bits of quotient select mask 704 #6 and the resolved partial remainder bits 412 to obtain the quotient bits 414.

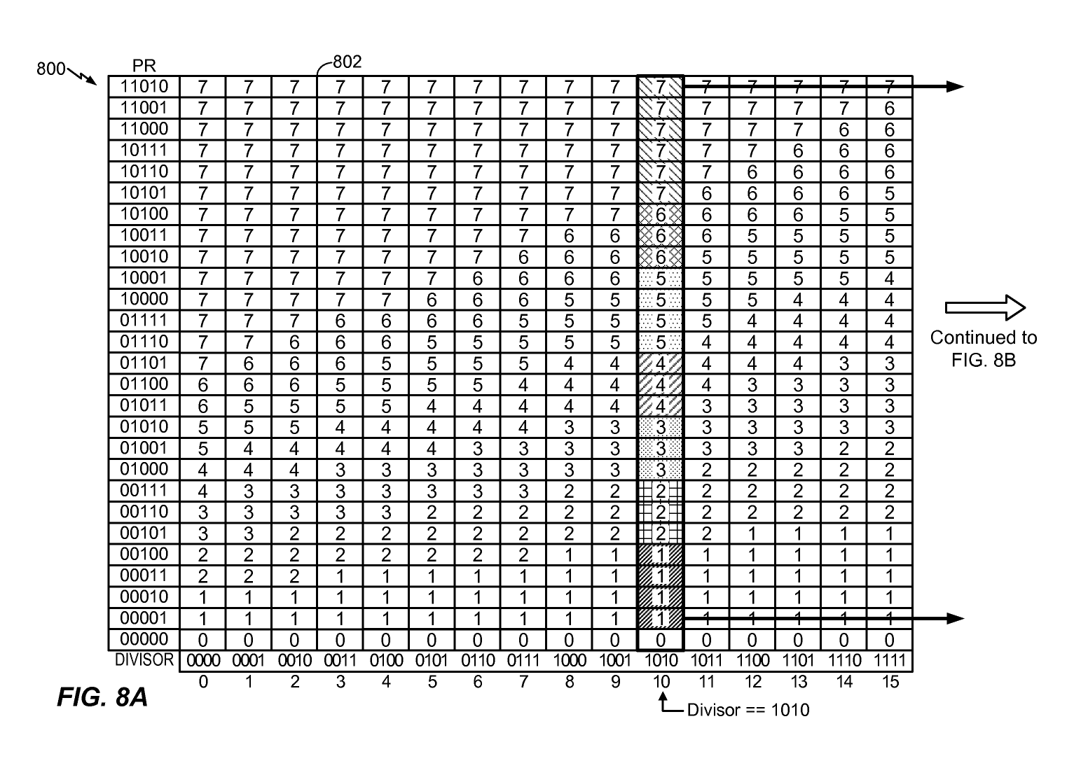

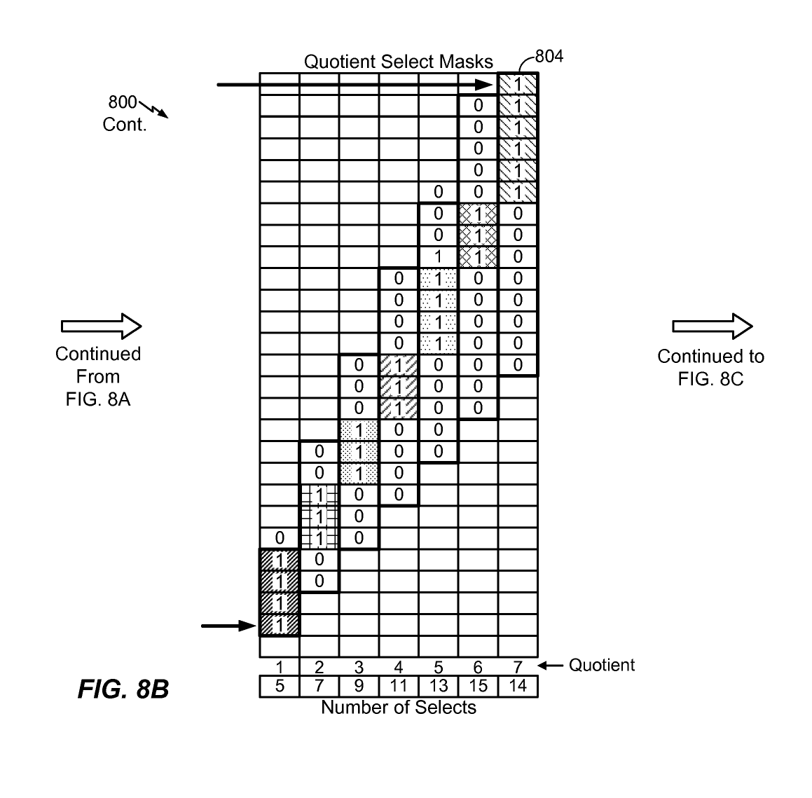

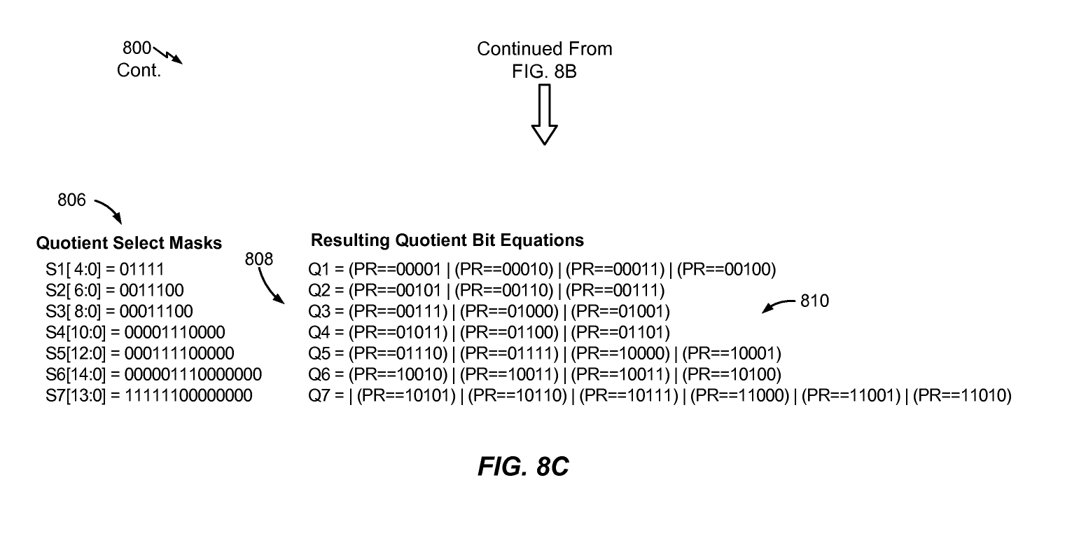

FIGS. 8A-C illustrate aspects of another high performance division and square root unit 800 suitable for implementing the method 600 according to an alternative exemplary aspect. Division and square root unit 800 includes table 802 (FIG. 8A), quotient select masks table 804 (FIG. 8B), quotient select masks 806 and resulting quotient bit equations 808 (FIG. 8C). Table 802 includes divisor or root estimates shown on the x-axis along numbered columns 0-15.

In FIGS. 8A-C, divisor 1010 is used to select corresponding column 10 (decimal equivalent of the binary divisor value 1010) of table 802. A “1” is inserted in all the entries of quotient select masks table 804 corresponding to column 10 and remaining entries are loaded with “0.” Quotient select masks 806 represent the resulting quotient select mask entries loaded into quotient select masks table 804 in this example. Only the partial remainder compares enabled by the quotient select mask entries of “1” may be relevant in this example. The resulting quotient bit equations in this example are shown in the resulting quotient bit equations 808.

Referring back to FIG. 4, quotient select masks 806 for divisor 1010 can be cached or stored in the block, column or quotient select mask 406, rather than storing the entire column 10. Division/root lookup logic 408 can then use the corresponding quotient bit equations 808 and the resolved partial remainder 412 to obtain the quotient bits 414.

FIG. 9 is a high-level block diagram of unit 900 suitable for implementing method 600 according to an exemplary implementation of the technology described herein. Unit 900 includes logic blocks 904, quotient select mask registers 906, partial remainder (PR) decoders 908, AND-OR blocks 910, and encoders 912. Unit 900 is used to generate the quotient 912 using quotient select mask registers 906. Quotient select mask registers include a logical expression or logical combination of one or more bits of the divisor and one or more bits of partial remainders.

In one implementation, the logic blocks 904 encode the column selected by divisor or root estimate 902 into quotient select mask registers 906 (which can be cached or stored in column or quotient select mask 406 of FIG. 4, for example). The quotient select masks are formed from a logical combination of divisor or root estimate 902 and partial remainder decodes of block 908. Accordingly, quotient select mask registers 906 have patterns of “0”s and “1”s stored therein, and the logical combination comprises comparing one or more bits of the current partial remainder with preselected partial remainder constants, and performing a logical AND on a result of the comparison with the quotient select registers. In the illustrated implementation, quotient select mask registers 906 are bitwise ANDed with the associated partial remainder decodes of block 908 and are ORed together to form a “1-hot” decoded quotient using the AND-OR blocks 910 (e.g., in division/root lookup logic 408 using the resolved partial remainder bits 412). The 1-hot decoded quotient can be encoded into traditional binary representation by the encoder 912 to provide the quotient bits 414 of FIG. 4, for example.

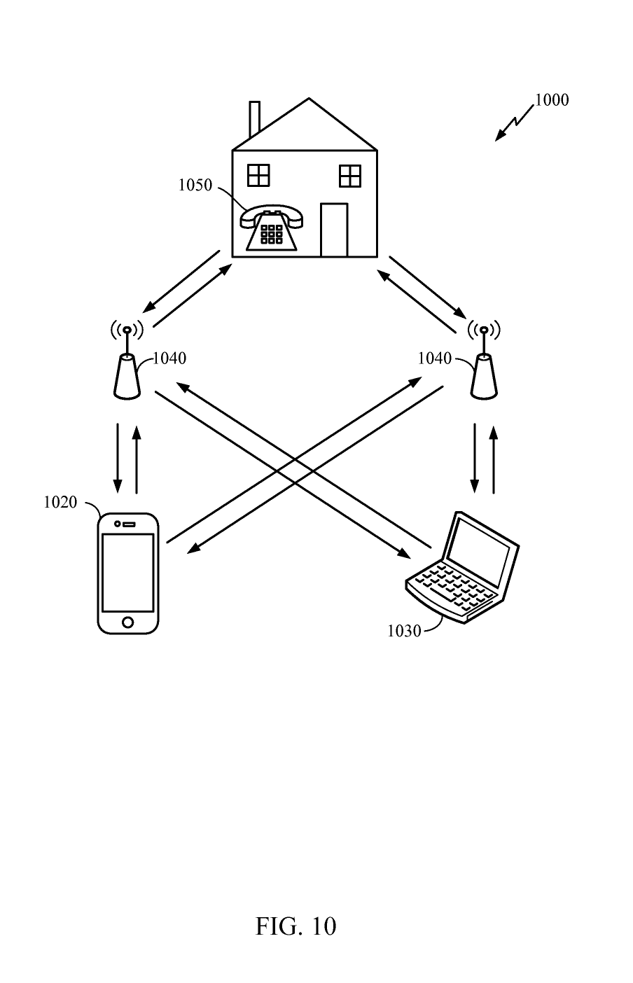

FIG. 10 illustrates an exemplary wireless communication system 1000 in which a division/root computation unit according to this disclosure may be advantageously employed. For purposes of illustration, FIG. 10 shows three remote units 1020, 1030, and 1050 and two base stations 1040. In FIG. 10, remote unit 1020 is shown as a mobile telephone, remote unit 1030 is shown as a portable computer, and remote unit 1050 is shown as a fixed location remote unit in a wireless local loop system. For example, the remote units may be mobile phones, hand-held personal communication systems (PCS) units, portable data units such as personal data assistants, GPS enabled devices, navigation devices, settop boxes, music players, video players, entertainment units, fixed location data units such as meter reading equipment, or any other device that stores or retrieves data or computer instructions, or any combination thereof. Any of remote units 1020, 1030, and 1050 may include a division/root computation unit as disclosed herein.

Although FIG. 10 illustrates remote units according to the teachings of the disclosure, the disclosure is not limited to these exemplary illustrated units. Aspects of the disclosure may be suitably employed in any device which includes active integrated circuitry including memory and on-chip circuitry for test and characterization.

Although steps and decisions of various methods may have been described serially in this disclosure, some of these steps and decisions may be performed by separate elements in conjunction or in parallel, asynchronously or synchronously, in a pipelined manner, or otherwise. There is no particular requirement that the steps and decisions be performed in the same order in which this description lists them, except where explicitly so indicated, otherwise made clear from the context, or inherently required. It should be noted, however, that in selected variants the steps and decisions are performed in the order described above. Furthermore, not every illustrated step and decision may be required in every implementation/variant in accordance with the invention, while some steps and decisions that have not been specifically illustrated may be desirable or necessary in some implementations/variants in accordance with the invention.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software, or combinations of both. To show clearly this interchangeability of hardware and software, various illustrative components, blocks, modules, circuits, and steps have been described above generally in terms of their functionality. Whether such functionality is implemented as hardware, software, or combination of hardware and software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an access terminal. Alternatively, the processor and the storage medium may reside as discrete components in an access terminal.

Accordingly, an aspect of the invention can include a computer readable media embodying a method of performing a division/root computation operation using cached information for quotient/root lookup in an SRT algorithm implementation. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of performing a division, the method comprising:
selecting a column of a lookup table according to a Sweeney, Robertson, and Tocher (SRT) algorithm for the division, the selected column corresponding to a divisor of the division;
caching information related to the selected column in a high-speed memory;
iteratively performing the division using the cached information, comprising:
determining a quotient from the cached information using a current partial remainder in each iteration; and
generating a next partial remainder based on the quotient, the divisor, and the current partial remainder.

2. The method of claim 1, wherein generating the next partial remainder comprises subtracting the divisor multiplied by the quotient from the current partial remainder.

3. The method of claim 2, comprising multiplying the divisor with the quotient using a multiple select multiplexer for selecting a multiple of the divisor, where the multiple is the quotient.

4. The method of claim 1, wherein caching information related to the selected column comprises caching all quotient values for the divisor from the lookup table.

5. The method of claim 1, wherein caching information related to the selected column comprises caching quotient select masks for the divisor from the lookup table.

6. The method of claim 5, comprising forming the quotient select masks from a logical combination of the divisor and the current partial remainder.

7. The method of claim 5, wherein the quotient select masks comprise quotient select registers which have patterns of “0”s and “1”s stored therein and the logical combination comprises comparing one or more bits of the current partial remainder with preselected partial remainder constants, and performing a logical AND on a result of the comparison with the quotient select registers.

8. The method of claim 7, comprising (n−1) quotient select registers where n is equal to 2̂(radix), and where the radix is an indication of the number of bits of the quotient.

9. The method of claim 1, comprising determining the quotient from the cached information using only a preselected number of most significant bits (MSBs) of the current partial remainder.

10. The method of claim 9, wherein the preselected number of MSBs of the current partial remainder are determined by adding only the most significant bits of a pair of redundant partial remainders from a previous iteration.

11. The method of claim 1, comprising storing the next partial remainder in a redundant form.

12. The method of claim 1, further comprising storing the quotient in one or more quotient registers including a developed quotient (Q) register and a developed quotient minus one (Q−1) register.

13. The method of claim 1 comprising selecting the column based on a preselected number of one or more most significant bits (MSBs) of the divisor.

14. The method of claim 1, wherein the current partial remainder for a first iteration is a dividend of the division.

15. A method of performing a root computation, the method comprising:
selecting a column of a lookup table according to a Sweeney, Robertson, and Tocher (SRT) algorithm for the root computation, the selected column corresponding to a root estimate of the root computation;
caching information related to the selected column in a high-speed memory;
iteratively performing the root computation using the cached information, comprising:
determining a root from the cached information using a current partial remainder in each iteration; and
generating a next partial remainder based on the root, the root estimate, and the current partial remainder.

16. A processor comprising:
a memory configured to store a lookup table according to a Sweeney, Robertson, and Tocher (SRT) algorithm for a division/root computation;
a high-speed memory configured to cache information related to a selected column of the lookup table, the selected column corresponding to a divisor/root estimate; and
a division/root computation unit configured to iteratively perform division/root computation using the cached information, comprising a division/root lookup logic configured to determine a quotient/root from the cached information based on a current partial remainder in each iteration, and generate a next partial remainder based on the quotient/root, the divisor/root estimate, and the current partial remainder.

17. The processor of claim 16, further comprising:
a multiple select multiplexer to select a multiple of the divisor/root estimate based on the quotient/root; and
a partial remainder subtractor to generate a next partial remainder as the multiple of the divisor/root estimate subtracted from the current partial remainder.

18. The processor of claim 16, wherein the cached information comprises all quotient/root values for the divisor/root estimate in the selected column of the lookup table.

19. The processor of claim 16, wherein the cached information comprises quotient/root select masks based on a logical combination of the divisor/root estimate for the selected column of the lookup table.

20. The processor of claim 19, wherein the quotient/root select masks comprise quotient/root select registers which have patterns of “0”s and “1”s stored therein and the logical combination comprises comparison of one or more bits of the current partial remainder with preselected partial remainder constants, and AND functions of a result of the comparison with the quotient/root select registers.

21. The processor of claim 20, comprising (n−1) quotient/root select registers where n is equal to 2̂(radix), and where the radix is an indication of the number of bits of the quotient/root.

22. The processor of claim 16, wherein the division/root lookup logic is configured to determine the quotient/root from the cached information based on only a preselected number of most significant bits (MSBs) of the current partial remainder in each iteration.

23. The processor of claim 22, comprising a carry-propagate adder (CPA) configured to add only the MSBs of a pair of redundant partial remainders from a previous iteration.

24. The processor of claim 16, comprising a pair of redundant partial remainder registers to store the next partial remainder in a redundant form.

25. The processor of claim 16, further comprising a developed quotient/root register (Q) and a developed quotient/root minus one register (Q−1) to store the quotient/root.

26. The processor of claim 16 wherein the selected column is based on a preselected number of one or more most significant bits (MSBs) of the divisor/root estimate.

27. The processor of claim 16, wherein the current partial remainder for a first iteration is a dividend/radicand.

28. A processing system comprising:
means for storing a lookup table according to a Sweeney, Robertson, and Tocher (SRT) algorithm for a division/root computation;
caching means for caching information related to a selected column of the lookup table, the selected column corresponding to a divisor/root estimate; and
means for iteratively performing division/root computation using the cached information based on means for determining a quotient/root from the cached information using a current partial remainder in each iteration, and means for generating a next partial remainder using the quotient/root, the divisor/root estimate, and the current partial remainder.

29. The processing system of claim 28, wherein the caching means comprises all quotient/root values for the divisor/root estimate for the selected column.

30. The processing system of claim 28, wherein the caching means comprises combinational logic for determining quotient/root values based on the divisor/root estimate and the current partial remainder.
